(19) United States
(12) Patent Application Publication
(10) Pub. No.: US 2012/0301569 A1
(43) Pub. Date: Nov. 29, 2012

(54) PATTERN TRANSFERRING APPARATUS AND PATTERN TRANSFERRING METHOD

(75) Inventors: Mitsuru Hasegawa, Hitachi (JP); Masahiko Ogino, Hitachi (JP); Keiji Sakaue, Shibata (JP); Kazunari Sugai, Narashino (JP); Daisuke Shimao, Tainai (JP)

(73) Assignee: HITACHI INDUSTRIAL EQUIPEMENT SYSTEMS CO., LTD., Tokyo (JP)

(21) Appl. No.: 13/574,064

(22) PCT Filed: Dec. 28, 2010
(86) PCT No.: PCT/JP2010/073689

§ 371 Date: Jul. 19, 2012

(30) Foreign Application Priority Data
Jan. 19, 2010 (JP) 2010-009004

(51) Int. Cl. B29C 59/04

(52) U.S. Cl. 425/385

(57) ABSTRACT

Provided is a pattern transferring apparatus (1A) which presses a belt-shaped mold (2) with a fine convex concave pattern and a transfer target material (3) against each other, releases the mold (2) from the transfer target material (3), thereby to transfer the convex concave pattern onto a surface of the transfer target material (3). The apparatus includes a pressing mechanism (4A) that presses the mold (2) and the transfer target material (3) against each other, and a supply mechanism for a mold releasing agent (7), which supplies a mold releasing agent to the mold (2). Accordingly, the pattern transferring apparatus (1A) may need no renewable process of the continuously used mold (2), allowing the excellent mold releasing performance of the mold (2) to be maintained.

### TECHNICAL FIELD

The present invention relates to a pattern transferring apparatus and a pattern transferring method, for transferring a fine convex concave pattern on a transfer target material by nanoimprinting.

### BACKGROUND

In recent years, various kinds of materials having a fine convex concave pattern formed on the surface thereof are used in the fields of an optical component like an antireflection film for a liquid crystal display and a light guiding panel, a biological device like a cell culture sheet, and an electronic device like a solar battery and a light emitting device, in order to enhance the performance thereof to exert a desired function,.

A nanoimprinting technique has been known as a conventional method for forming a fine convex concave pattern (see, for example, Patent Literature 1, Patent Literature 2, and Non-patent Literature 1). The nanoimprinting is a technique of pressing a mold having a fine convex concave pattern in a nano meter order to a resin applied onto a surface of a substrate to transfer such a pattern thereto. The transferring techniques disclosed in Patent Literature 1, Patent Literature 2, and Non-patent Literature 1 are to press a tabular mold against a resin as a nanoimprinter.

Moreover, another transferring technique is also known, which uses a roller type mold (see, for example, Patent Literature 3 and Non-patent Literature 2). According to this transferring technique, a transfer target material can be continuously supplied to a continuously rotating mold, and thus the transfer process can be more accelerated than a nanoimprinting transferring technique using a tabular mold (see, for example, Patent Literature 1, Patent Literature 2, and Non-patent Literature 1).

Meanwhile, according to the above-described transferring techniques, a mold releasing treatment performed in advance onto a surface of a mold has been known. For example, Patent Literature 4 discloses a transferring technique that uses a roller type mold to which a mold releasing agent has been applied in advance.

### PRIOR ART DOCUMENTS

### Patent Literatures

Patent Literature 1: U.S. Pat. No. 52,599,626

Patent Literature 2: U.S. Pat. No. 5,772,905

Patent Literature 3: JP 2006-326948 A

Patent Literature 4: JP H06-12707 A

### Non-patent Literatures

Non-patent Literature 1: S. Y. Chou et al., Appl. Phys. Lett., vol. 67, p. 3114 (1995)

Non-patent Literature 2: Hua Tan et al., J. Vac. Sci. Technol. B16 (6), p. 3926 (1998)

### DISCLOSURE OF INVENTION

### Problems to be Solved by the Invention

According to the conventional transferring techniques that use the mold to which the mold releasing agent has been applied in advance (see, for example, Patent Literature 4), the mold releasing performance gradually deteriorates upon repeating the transferring from the mold, which may cause a transferring failure and clogging of the mold. Hence, according to the conventional transferring techniques, when the mold releasing performance deteriorates, such a mold is replaced with new one. However, expensiveness of the mold having a convex concave pattern in a nano meter order results in the increased running costs of a pattern transferring apparatus.

Therefore, a renewable process of applying the mold releasing agent again to the mold is considerable. However, it is necessary to eliminate the mold releasing agent having the deteriorated mold releasing performance and the clogging from the mold by conducting a heating treatment and a chemical treatment in advance before performing such a renewable process.

However, the heating treatment and the chemical treatment for eliminating the mold releasing agent and the clogging may largely damage the convex concave pattern of the mold in the nano meter order. More specifically, the mold releasing agent used in the conventional transferring techniques (see, for example, Patent Literature 4) increases the binding property of the mold releasing agent by making the releasing agent covalently bind chemical species on the surface of the mold. Accordingly, decomposing elimination of the mold releasing agent by conducting a heating treatment, or dissolving elimination by using a chemical agent may deteriorate, deform, or damage the mold itself thereby to damage the fine convex concave pattern.

Accordingly, an object of the present invention is to provide a pattern transferring apparatus and a pattern transferring method, which need no renewable process of a continuously used mold, and can maintain good releasing performance of the mold.

### Means for Solving the Problems

To achieve the object, an aspect of the present invention provides a pattern transferring apparatus which presses a belt-shaped mold formed with a fine convex concave pattern and a transfer target material against each other, and releases the mold from the transfer target material thereby to transfer the convex concave pattern on a surface of the transfer target material. The apparatus includes: a pressing mechanism that presses the mold and the transfer target material against each other; and a supply mechanism for a mold releasing agent that supplies a mold releasing agent to the mold.

To achieve the object, another aspect of the present invention provides a pattern transferring apparatus which presses a belt-shaped mold with a fine convex concave pattern and a transfer target material against each other, and releases the mold from the transfer target material thereby to transfer the fine convex concave pattern on a surface of the transfer target material. Herein, the apparatus includes: a pressing mechanism that presses the mold and the transfer target material against each other; a mold feeder mechanism that feeds the mold along a mold feeding pathway defined in advance so as to supply the mold to the pressing mechanism; a feeder mechanism for a transfer target material that feeds the transfer target material along a feeding pathway for a transfer target material defined in advance so as to supply the transfer target material to the pressing mechanism; and a supply mechanism for a mold releasing agent that supplies a mold releasing agent to the mold over the mold feeding pathway.

To achieve the object, another aspect of the present invention provides a pattern transferring apparatus which presses a belt-shaped mold formed with a fine convex concave pattern and a first transfer target material against each other, and releases the mold from the first transfer target material to transfer the convex concave pattern on a surface of the first transfer target material. The apparatus comprises: a first pressing mechanism that presses the mold and the first transfer target material against each other; a mold feeder mechanism that feeds the mold along a mold feeding pathway defined in advance so as to supply the mold to the first pressing mechanism; a feeder mechanism for a first transfer target material that feeds the first transfer target material along a feeding pathway for a first transfer target material defined in advance so as to supply the first transfer target material to the first pressing mechanism; and a supply mechanism for a mold releasing agent that supplies a mold releasing agent to the mold over the mold feeding pathway. The pattern transferring apparatus further includes: a second pressing mechanism which is disposed at an upstream side of the mold feeding pathway over the first pressing mechanism, and presses the mold and a second transfer target material against each other; and a feeder mechanism for a second transfer target material that feeds the second transfer target material so as to supply the second transfer target material to the second pressing mechanism.

To achieve the object, another aspect of the present invention provides a pattern transferring method that repeats a pressing-transfer process of pressing a belt-shaped mold with a fine convex concave pattern and a transfer target material against each other to transfer the convex concave pattern to the transfer target material, and a releasing process of releasing the mold from the transfer target material to continuously transfer the convex concave pattern to the transfer target material. The method further includes a supply process for a mold releasing agent of supplying a mold releasing agent to the mold between the releasing process and the pressing-transfer process.

To achieve the object, another aspect of the present invention provides a pattern transferring method including: a feeding process of feeding a belt-shaped mold with a fine convex concave pattern along a mold feeding pathway defined in advance, and feeding a transfer target material to which the convex concave pattern is to be transferred along a feeding pathway for a transfer target material defined in advance; a pressing-transfer process of pressing the mold and the transfer target material against each other during the feeding process of the mold and the transfer target material to transfer the convex concave pattern to the transfer target material; a releasing process of releasing the mold from the transfer target material; and a mold-releasing-agent supply process of supplying a mold releasing agent to the mold over the mold feeding pathway before the pressing-transfer process. Note the pressing-transfer process, the releasing process and the mold-releasing-agent supply process are respectively executed at different locations over the mold feeding pathway.

To achieve the object, another aspect of the present invention provides a pattern transferring method including: a feeding process of feeding in an endless manner a belt-shaped mold with a fine convex concave pattern along an annular mold feeding pathway, and feeding a transfer target material to which the convex concave pattern is to be transferred along a feeding pathway a for a transfer target material defined in advance; a pressing-transfer process of pressing the mold and the transfer target material against each other during the feeding process of the mold and the transfer target material to transfer the convex concave pattern to the transfer target material; and a releasing process of releasing the mold from the transfer target material. Herein, the mold fed in an endless manner repeats the pressing-transfer process and the releasing process to the fed transfer target material. Further, the pattern transferring method comprising a mold-releasing-agent supply process of supplying a mold releasing agent to the mold over the mold feeding pathway before the pressing-transfer process. Note the pressing-transfer process, the releasing process, and the mold-releasing-agent supply process are respectively executed at different locations over the mold feeding pathway.

To achieve the object, another aspect of the present invention provides a pattern transferring method that repeats a pressing-transfer process of pressing a belt-shaped mold formed with a fine convex concave pattern and a transfer target material against each other to transfer the convex concave pattern to the transfer target material, and a releasing process of releasing the mold from the transfer target material to continuously transfer the convex concave pattern to the transfer target material. Here, a first mold releasing layer made of a first mold releasing agent is formed in advance on the mold. Further, the pattern transferring method includes a mold-releasing-agent supply process of supplying another kind of a second mold releasing agent different from the first mold releasing agent with a surface of the first mold releasing layer during a period between the releasing process and the pressing-transfer process.

To achieve the object, another aspect of the present invention provides a pattern transferring method including: a feeding process of feeding a belt-shaped mold with a fine convex concave pattern along a mold feeding pathway defined in advance, the mold being formed with a first mold releasing layer made of a first mold releasing agent in advance, and feeding a transfer target material to which the convex concave pattern is to be transferred along a mold feeding pathway defined in advance; a pressing-transfer process of pressing the mold and the transfer target material against each other during the feeding process of the mold and the transfer target material to transfer the convex concave pattern to the transfer target material; a releasing process of releasing the mold from the transfer target material; and a mold-releasing-agent supply process of supplying another kind of a second mold releasing agent different from the first mold releasing agent with a surface of the first mold releasing layer on the mold over the mold feeding pathway before the pressing-transfer process. Herein, the pressing-transfer process, the releasing process and the mold-releasing-agent supply process are respectively executed at different locations over the mold feeding pathway.

### Advantageous Effects of the Invention

According to the present invention, a pattern transferring apparatus and a pattern transferring method are provided, which need no renewable process of a continuously used mold, and can maintain an excellent mold releasing performance.

### BRIEF DESCRIPTION OF DRAWINGS

FIG. 1 is an explanatory construction diagram schematically showing a pattern transferring apparatus according to a first embodiment of the present invention;

FIG. 2 is an explanatory construction diagram schematically showing a pattern transferring apparatus according to a second embodiment of the present invention;

FIG. 3 is an explanatory construction diagram schematically showing a pattern transferring apparatus according to a third embodiment of the present invention;

FIG. 4 is an explanatory construction diagram schematically showing a pattern transferring apparatus according to a fourth embodiment of the present invention;

FIG. 5 is an explanatory construction diagram schematically showing a pattern transferring apparatus according to a fifth embodiment of the present invention;

FIG. 6A is an explanatory construction diagram schematically showing a pattern transferring apparatus according to a sixth embodiment of the present invention;

FIG. 6B is an explanatory operation diagram for the pattern transferring apparatus according to the sixth embodiment of the present invention;

FIG. 7 is an explanatory construction diagram showing a modified example of the pattern transferring apparatus according to the second embodiment of the present invention; and

FIG. 8 is an explanatory construction diagram of a pattern transferring apparatus shown as a comparative example of the present invention.

### EMBODIMENTS FOR CARRYING OUT THE INVENTION

Explanations will be given in detail of first to sixth embodiments of the present invention with reference to the accompanying drawings as needed.

### First Embodiment

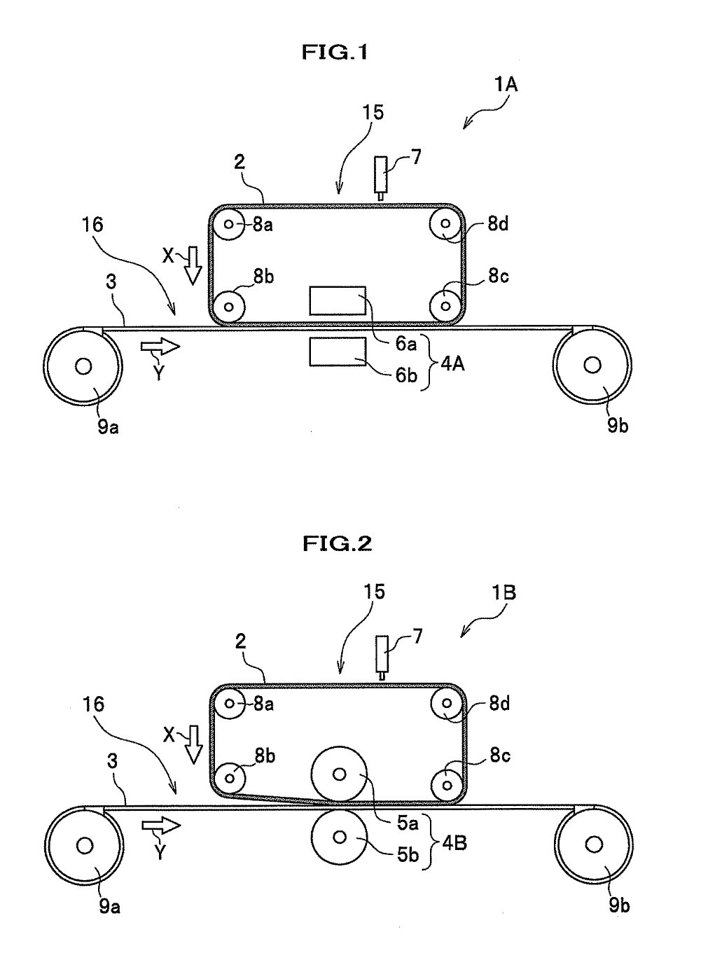

As shown in FIG. 1 of an explanatory construction diagram, a pattern transferring apparatus 1A of this embodiment includes a mold feeder mechanism 10 (or 8a to 8d) that feeds a mold 2 along a preset mold feeding pathway 15, a feeder mechanism for a transfer target material 11 (or 9a and 9b) that feeds a transfer target material 3 along a preset feeding pathway for a transfer target material 16, a pressing mechanism 4A that presses the mold 2 and the transfer target material 3 with each other, and a supply mechanism for a mold releasing agent 7 that supplies a mold releasing agent to the mold 2.

The mold 2 of this embodiment is formed in an annular belt shape to be the endless belt mold 2. This mold 2 has a fine convex concave pattern (unillustrated) which is to be transferred on the transfer target material 3 and is formed on a lateral surface of the annular belt contacting the transfer target material 3. The convex concave pattern is a pattern having concavities and convexities continuously formed in a repeated manner. Herein, the depth of the concavity (or the height of convexity), the width of the concavity (or the width of the convexity), and the pitch between the concavities (or the pitch between the convexities) are formed in a nano meter order.

Note that the convex concave shape can be set as needed depending on the application of micro fine structures obtained by the pattern transferring apparatus 1A including, for example, a columnar shape, a hole shape, and a lamellar shape (or a pleat shape). The convex concave pattern may be formed across the whole circumference of the mold 2, or may be formed in a part of the mold 2.

The material of the mold 2 of this embodiment is not limited to any particular one as far as it has flexibility and can realize required strength and processing accuracy including, for example, various metals and resins. Here, nickel is desirable as a metallic material. A polyimide resin and a photo-curable resin are desirable as resin materials. The above mentioned mold 2 can be a composite laminate integrated by a metal like nickel or a resin like a polyimide resin having the above-explained convex concave pattern, and base members such as stainless-steel or an aromatic polyamide resin (e.g., Kevlar (registered trademark) fiber), which supports the aforementioned metal or resin.

The mold feeder mechanism 10 (or 8a to 8d) of this embodiment includes a plurality of rolls 8a, 8b, 8c, and 8d across which the annular mold 2 is suspended, and driving mechanisms (unillustrated) like stepping motors that intermittently rotate to drive those rolls 8a, 8b, 8c, and 8d per a preset rotational angle. The rolls 8a, 8b, 8c, and 8d of this embodiment are disposed so as to contact the internal surface side of the annular mold 2.

The above-explained driving mechanisms intermittently rotate counterclockwise (left rotation) respective rolls 8a, 8b, 8c, and 8d to intermittently rotate the annular mold 2 to the left, and intermittently feed the mold 2 to the pressing mechanism 4A as discussed hereinafter per each predetermined length in an endless manner. The rotational angle of the driving mechanisms (unillustrated) of the rolls 8a, 8b, 8c, and 8d is set in such a way that the length of the mold 2 fed to the pressing mechanism 4A becomes, for example, a predetermined length. In FIG. 1, an arrow indicated by a reference symbol X shows a feeding direction of the mold 2.

The two rolls 8b and 8c among the four rolls 8a, 8b, 8c, and 8d, disposed so as to press the mold 2 against the transfer target material 3 fed by the feeder mechanism for a transfer target material 11 (or 9a and 9b) as discussed hereinafter, function to feed the mold 2 by the roll 8b at the upstream side of the fed mold 2 so that the mold 2 contacts the transfer target material 3, and to release the mold 2 from the transfer target material 3 by the roll 8c at the downstream side. The rolls are not limited to those four rolls 8a, 8b, 8c, and 8d, and as long as the rolls function at least as the above-explained rolls 8b and 8c, the number of rolls may be three or five or more.

The transfer target material 3 of this embodiment is formed in an elongated belt shape having substantially same width as that of the mold 2, and is made of a film of a thermoplastic resin. The thermoplastic resin can be selected accordingly depending on the application of the micro fine structures obtained by the pattern transferring apparatus 1A. The thermoplastic resin having a glass transition temperature Tg of 100° C. to 160° C. are desirable including, more specifically polystyrene, polycarbonate, and polymethylmethacrylate. The transfer target material 3 is rolled and retained by a feeder reel 9a of the feeder mechanism for a transfer target material 11 (or 9a and 9b) as discussed hereinafter. In this embodiment, it is assumed that the transfer target material 3 is a monolayer film made of a thermoplastic resin, while the material 3 may be a multilayer structure having at least an outermost layer at one side made of a thermoplastic resin.

The feeder mechanism for a transfer target material 11 (or 9a and 9b) of this embodiment includes the feeder reel 9a that retains the transfer target material 3 in a rolled manner, a wind-up reel 9b that winds up the transfer target material 3 fed from the feeder reel 9a, and a driving mechanism (unillustrated) like a stepping motor that intermittently rotates and drives at least the wind-up reel 9b per each preset rotational angle so as to wind up the transfer target material 3. The driving mechanisms intermittently rotate the wind-up reel 9b per each preset rotational angle, thereby intermittently winding up the transfer target material 3 per each predetermined length set in advance. In other words, the wind-up reel 9b draws the transfer target material 3 from the feeder reel 9a per each predetermined length by the driving mechanisms, and feeds the drawn transfer target material to the pressing mechanism 4A as discussed hereinafter. Note that in FIG. 1, an arrow indicated by a reference symbol Y shows the feeding direction of the transfer target material 3.

The driving mechanism of the wind-up reel 9b of this embodiment makes the timing, at which the transfer target material 3 is fed to the pressing mechanism 4A, match the timing at which the mold 2 is fed to the pressing mechanism 4A as synchronized with the driving mechanisms of the rolls 8a, 8b, 8c, and 8d, thereby making the length of the transfer target material 3 fed to the pressing mechanism 4A consistent with the length of the mold 2 fed to the pressing mechanism 4A.

That is, the pattern transferring apparatus 1A of this embodiment feds the mold 2 and the transfer target material 3 to the pressing mechanism 4A with the mold and the transfer target material being overlapped with each other. According to this embodiment, only the wind-up reel 9b is provided with the driving mechanism, while a driving mechanism that rotates the feeder reel 9a synchronized with the rotation of the wind-up reel 9b may be further provided.

When the mold 2 and the transfer target material 3 tightly adhere to each other, even if the feeder mechanism for a transfer target material 11 (or 9a and 9b) is not provided with the driving mechanism, the mold 2 and the transfer target material 3 can be fed simultaneously by driving the mold feeder mechanism 10 (or 8a to 8d) for feeding the mold 2 to the pressing mechanism 4A. Moreover, the feeder mechanism for a transfer target material 11 (or 9a and 9b) may be provided with a tension adjuster mechanism (unillustrated) that suppresses slack of the transfer target material 3.

The pressing mechanism 4A of this embodiment is constructed to tuck down the mold 2 fed between the roll 8b and the roll 8c and the transfer target material 3 fed through such a feeding section so as to overlap the mold 2 and press the mold 2 and the transfer target material 3 against each other. The pressing mechanism 4A has an upper pressing member 6a and a lower pressing member 6b, which are disposed so as to face with each other to tuck down the mold 2 and the transfer target material 3 at a section between the roll 8b and the roll 8c, and driving devices (unillustrated) which press the upper pressing member 6a and the lower pressing member 6b against the mold 2 and the transfer target material 3, respectively, and remove the upper and lower pressing members apart from those mold 2 and the transfer target material 3. The pressing and removing operations of the driving devices are carried out when the feeding of the mold 2 and the transfer target material 3 is halted.

Moreover, a heater (unillustrated) is built in the upper pressing member 6a. The heater heats the transfer target material 3 through the mold 2 pressed against the transfer target material 3, thereby heating the transfer target material 3 (the thermoplastic resin) to a temperature equal to or higher than the glass transition temperature Tg thereof. According to this embodiment, it is assumed that only the upper pressing member 6a is provided with a heater. However, only the lower pressing member 6b may be provided with a heater, or both upper pressing member 6a and lower pressing member 6b may be provided with respective heaters.

The supply mechanism for a mold releasing agent 7 of this embodiment supplies the mold releasing agent to an external surface side of the mold 2 fed along the annular mold feeding pathway 15, i.e., to a surface where the above-explained convex concave pattern is formed.

The supply mechanism for a mold releasing agent 7 of this embodiment is disposed so as to supply the mold releasing agent to the mold 2 over the mold feeding pathway 15 in the section from the roll 8d to the roll 8a, while the position where the supply mechanism for a mold releasing agent 7 is disposed is not limited to such a position. For example, the supply mechanism for a mold releasing agent 7 may be disposed so as to supply the mold releasing agent over the mold feeding pathway 15 at a section from the roll 8c to the roll 8d, or a section from the roll 8a to the roll 8b. Note that the supply mechanism for a mold releasing agent 7 of this embodiment can be disposed at the downstream side distant from the position of the pressing mechanism 4A where the mold 2 is heated, and thus the mold releasing agent can be supplied after the mold 2 is sufficiently cooled. As a result, when, for example, a solution of the mold releasing agent containing a solvent with a low boiling point is used, it becomes possible to prevent such a solvent from instantaneously evaporating, allowing the mold releasing agent to be applied to the mold 2 widespread uniformly. Moreover, the supply mechanisms for a mold releasing agent 7 of this embodiment may be disposed at plural locations over the mold feeding pathway 15.

The supply mechanism for a mold releasing agent 7 can employ any construction as long as it can supply the mold releasing agent to the surface of the mold 2 having the convex concave pattern to form a mold releasing layer, and for example, can employ a construction which soaks the mold 2 in the mold releasing agent solution or applies the mold releasing agent to the mold 2. The method of applying the mold releasing agent can be any of, for example, spraying, ink jetting, dispensing, or brushing. In the case of a solid mold releasing agent at an ambient temperature, a solution or a dispersion liquid may be prepared and used by an appropriate solvent or a dispersion medium.

Next, an explanation will be given of the mold releasing agent supplied from the supply mechanism for a mold releasing agent 7. The mold releasing agent corresponds to a “second mold releasing agent” described in the claims. Note that a “first mold releasing agent” in the claims means, as will be explained in detail through a pattern forming method as discussed hereinafter, a mold releasing agent applied to the mold 2 in advance, and is distinguished from the mold releasing agent (the second mold releasing agent) supplied from the supply mechanism for a mold releasing agent 7.

It is desirable that the mold releasing agent supplied from the supply mechanism for a mold releasing agent 7 should be a so-called non-reactive mold releasing agent that does not covalently bind the chemical species on the surface of the mold 2, and more specifically, a fluorinated mold releasing agent is desirable. In particular, a fluorinated mold releasing agent that has a polar group at a molecular end is desirable, and more specifically, a fluorinated mold releasing agent having at least one kind of groups at a molecular end is desirable, including a hydroxyl group, an ether group, and an ester group.

Next, an explanation will be given of a pattern transferring method while explaining an operation of the pattern transferring apparatus 1A of this embodiment. According to the pattern transferring apparatus 1A, with the transfer target material 3 shown in FIG. 1 being unset, the supply mechanism for a mold releasing agent 7 supplies the mold releasing agent to the mold 2 while the mold 2 is being fed by the mold feeder mechanism 10 (or 8a to 8d). Next, the mold releasing layer is formed across the whole external circumference of the mold 2 suspended on the rolls 8a, 8b, 8c, and 8d, i.e., the entire convex concave pattern of the mold 2. The explanation is given of the case in which the mold releasing layer is formed by the supply of the mold releasing agent from the supply mechanism for a mold releasing agent 7. However, the mold 2 having the mold releasing layer formed in advance may be set to the pattern transferring apparatus 1A. In this case, the mold releasing agent applied to the mold 2 in advance may be the same as the mold releasing agent supplied from the supply mechanism for a mold releasing agent 7, or may be a different agent.

Next, as shown in FIG. 1, the end of the transfer target material 3 drawn from a feeder reel 9a is attached to a wind-up reel 9b to set the feeding pathway for a transfer target material 16, and activate the pattern transferring apparatus 1A to actuate the mold feeder mechanism 10 (or 8a to 8d), the feeder mechanism for a transfer target material 11 (or 9a and 9b), the pressing mechanism 4A and the supply mechanism for a mold releasing agent 7.

Subsequently, the upper pressing member 6a and the lower pressing member 6b of the pressing mechanism 4A sandwich the mold 2 and the transfer target material 3 and press those against each other. At this time, the above-explained heater of the upper pressing member 6a heats the transfer target material 3 up to a temperature equal to or higher than the glass transition temperature Tg thereof, allowing the transfer target material to be plasticized (or semi-fluidized). As a result, the convex concave pattern of the mold 2 is transferred to the transfer target material 3.

Next, when the upper pressing member 6a and the lower pressing member 6b are removed apart from the mold 2 and the transfer target material 3, the temperature of the transfer target material 3 becomes lower than the glass transition temperature Tg, thereby to be cured. Conversely, with the upper pressing member 6a and the lower pressing member 6b being removed apart, the mold feeder mechanism 10 (or 8a to 8d) and the feeder mechanism for a transfer target material 11 (or 9a and 9b) feed the mold 2 and the transfer target material 3 located at the upstream side of the pressing mechanism 4A to the pressing mechanism 4A. Subsequently, like the above-explained operation, the upper pressing member 6a and the lower pressing member 6b press the mold 2 and the transfer target material 3 against each other, thereby transferring the convex concave pattern to the transfer target material 3.

According to the pattern transferring apparatus 1A of this embodiment, the feeding process of the mold 2 and the transfer target material 3 by the mold feeder mechanism 10 (or 8a to 8d) and the feeder mechanism for a transfer target material 11 (or 9a and 9b), and the pressing-transfer process of the convex concave pattern to the transfer target material 3 by the pressing mechanism 4A are continuously repeated.

Next, the transfer target material 3 having the convex concave pattern transferred thereto and reaching the roll 8c is fed toward the wind-up reel 9b, and the mold 2 is fed from the roll 8c to the roll 8d. Accordingly, the mold 2 is released from the transfer target material 3 at the position of the roll 8c. That is, the roll 8c of this embodiment serves as a release roll.

Moreover, according to the pattern transferring apparatus 1A, the mold 2 in the belt shape is used, and thus a predetermined distance can be ensured between the pressing mechanism 4A and the roll 8c. Hence, the heat at the time of transferring the convex concave pattern sufficiently dissipates, allowing the mold 2 to be released from the surely cured transfer target material 3. Furthermore, although it is not illustrated in the figure, if a cooling mechanism, such as an air blower or a cooling roll, is provided between the pressing mechanism 4A and the roll 8c, when it becomes necessary to increase the feeding speed in order to improve the productivity, the mold 2 and the transfer target material 3 can be sufficiently cooled, and thus the mold releasing can be surely carried out. The above-explained process corresponds to a “releasing process” described in the claims.

In such a releasing process, the mold 2 has the improved mold releasing performance to the transfer target material 3 due to the applied mold releasing agent, thereby suppressing a defect of the convex concave pattern transferred to the transfer target material 3. Accordingly, the improved mold releasing performance may prevent the convex concave pattern of the mold 2 from being clogged.

As explained above, according to a desirable pattern transferring method using a non-reactive mold releasing agent, the chemical species on the surface of the mold 2 and the mold releasing agent do not covalently bind each other, and the mold releasing agent is deposited on the surface of the mold 2. Hence, unlike the case using, for example, the reactive mold releasing agent covalently binding the mold 2, the mold releasing agent is likely to be removed from the mold 2. This might be disadvantageous at a glance since the fixing of the mold releasing agent to the mold 2 decreases. However, according to the findings by the inventors of the present invention based on experiments, when the reactive mold releasing agent is used, the fixing of the mold releasing agent to the mold 2 is superior to the non-reactive mold releasing agent. However, it is demonstrated that the decrease in the mold releasing performance of the reactive mold releasing agent does not uniformly and gradually progress across the whole surface of the mold releasing layer, while the above mentioned decrease occurs locally and suddenly.

Hence, when the mold 2 having the mold releasing performance decreased due to the repeated transfer of the convex concave pattern is treated in the renewable process, it is necessary to eliminate the deteriorated mold releasing agent from the mold 2 and then to apply a new mold releasing agent thereto. Moreover, when the reactive mold releasing agent is used, since the fixing is originally good, the elimination of the reactive mold releasing agent is difficult. Accordingly, when it is attempted to eliminate the deteriorated mold releasing agent from the mold 2, the mold 2 itself may be damaged as explained above.

Moreover, overcoating of a new mold releasing agent on the deteriorated mold releasing agent non-uniformly increases a thickness of the mold releasing layer formed on the surface of the mold 2, thereby to significantly decrease precision of the convex concave pattern formed in the nano meter order.

On the other hand, the non-reactive mold releasing agent does not chemically bind the mold 2, while the agent is only deposited thereon. Thus, the agent is eliminated from the mold 2 and moved to the transfer target material 3 when the mold 2 is released from the transfer target material 3. Accordingly, unlike the case of the reactive mold releasing agent that the mold releasing agent deteriorated due to the repeated transfer is left from the mold 2, the non-reactive mold releasing agent does not remain on the mold 2 in deteriorated conditions.

Moreover, according to the pattern transferring apparatus 1A of this embodiment, the transfer target material 3 having the convex concave pattern transferred thereto and released from the mold 2 is wound by the wind-up reel 9b, while at the same time, the mold 2 removing the non-reactive mold releasing agent is fed to the supply mechanism for a mold releasing agent 7.

Next, the pattern transferring apparatus 1A of this embodiment allows the supply mechanism for a mold releasing agent 7 to supply a new mold releasing agent to the mold 2. This process corresponds to a “supplying process for a mold releasing agent” described in the claims.

As explained above, according to a desirable pattern transferring method using the fluorinated mold releasing agent having a polar group at a molecular end, in particular, the fluorinated mold releasing agent having a hydroxyl group, an ether group, and an ester group may improve affinity of the mold releasing agent to the surface of the mold 2. This enables the mold releasing layer to be formed with a further uniform thickness.

The mold 2 to which the mold releasing agent is applied by the supply mechanism for a mold releasing agent 7 is fed again to the pressing mechanism 4A by the mold feeder mechanism 10 (or 8a to 8c). That is, a pattern forming method of this embodiment using the pattern transferring apparatus 1A comprises: a pressing-transfer process of pressing the mold 2 and the transfer target material 3 against each other to transfer the convex concave pattern while the mold 2 is being fed along the mold feeding pathway 15 and the transfer target material 3 is being fed along the feeding pathway for a transfer target material 16; a releasing process of releasing the mold 2 from the transfer target material 3; and a supplying process for a mold releasing agent of supplying the mold releasing agent to the mold 2 over the mold feeding pathway 15. The above mentioned processes are repeatedly carried out, allowing the mold 2 to continuously transfer the convex concave pattern onto the transfer target material 3. As a result, the pressing-transfer process, the releasing process, and the supplying process for the mold releasing agent are carried out at respectively different locations over the mold feeding pathway 15, and the supplying process for the mold releasing agent is carried out after the releasing process and before the pressing-transfer process.

According to the pattern transferring apparatus 1A and the pattern transferring method using the same as explained above, the renewable process of the continuously used mold 2 is unnecessary, enabling deterioration of the mold releasing performance of the mold 2 to be prevented.

Moreover, according to the above-explained pattern forming method, the mold releasing agent applied to the mold 2 in advance can be the reactive mold releasing agent, while the mold releasing agent supplied from the supply mechanism for a mold releasing agent 7 can be the above-explained non-reactive mold releasing agent.

A reactive mold releasing agent has, for example, a functional group which causes a silane coupling reaction with a hydroxyl group present on the surface of the mold 2 to produce covalent binding at a molecular end. For example, such a reactive mold releasing agent may be used, as including a functional group with reactive hydrogen, such as a hydroxyl group, an amino group, or a mercapto group, in a molecule.

According to such a pattern forming method, the reactive mold releasing agent applied to the mold 2 in advance corresponds to the “first mold releasing agent” described in the claims, and the mold releasing layer formed on the surface of the mold 2 by this mold releasing agent corresponds to a “first mold releasing layer” described in the claims. Moreover, the non-reactive mold releasing agent supplied from the supply mechanism for a mold releasing agent 7 corresponds to the “second mold releasing agent” described in the claims as explained above, and the mold releasing layer formed on the surface of the “first mold releasing layer” by this mold releasing agent corresponds to a “second mold releasing layer” described in the claims. According to such a pattern forming method, the good mold releasing performance of the mold 2 can be further surely maintained.

### Second Embodiment

Next, an explanation will be given of in detail a second embodiment of the present invention with reference to the accompanying drawings as needed. In this embodiment, the same structural element as in the first embodiment will be denoted by the same reference numeral, and the detailed explanation thereof will be omitted.

As shown in FIG. 2 of an explanatory construction diagram, a pattern transferring apparatus 1B of this embodiment employs the same construction as in the first embodiment except that the pattern transferring apparatus includes a pressing mechanism 4B having an upper roll 5a and a lower roll 5b instead of the upper pressing member 6a and the lower pressing member 6b shown in FIG. 1. Although it is assumed that the heater is disposed in the upper roll 5a, the heater may be disposed in at least either of the upper roll 5a and the lower roll 5b.

According to the pattern transferring apparatus 1B, the mold 2 and the transfer target material 3 overlapping with each other are supplied in between the upper roll 5a rotating counterclockwise (left rotation) and the lower roll 5b rotating clockwise (right rotation) thereby to be pressed against each other.

The pattern transferring apparatus 1B can accomplish the same advantages and effects as those of the pattern transferring apparatus 1A of the first embodiment, and also accomplish the following advantageous effect. According to the pattern transferring apparatus 1B, the mold 2 and the transfer target material 3 are continuously fed in the pressing mechanism 4B to form the convex concave pattern on the transfer target material 3. Hence, this pattern transferring apparatus 1B can more accelerate the transfer speed of the convex concave pattern than the pattern transferring apparatus 1A (see FIG. 1) of the first embodiment having the pressing mechanism 4A in the nanoimprinting type.

### Third Embodiment

Next, an explanation will be given of in detail a third embodiment of the present invention with reference to the accompanying drawings as needed. In this embodiment, the same structural element as in the first embodiment and the second embodiment will be denoted by the same reference numeral and the detailed explanation thereof will be omitted.

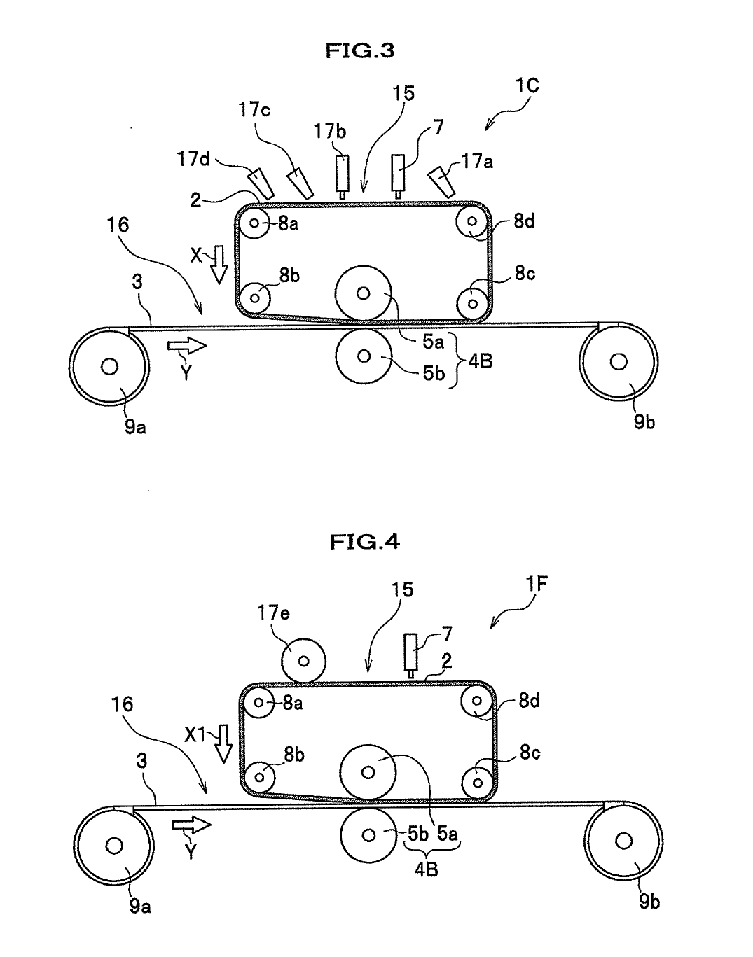

As shown in FIG. 3 of an explanatory construction diagram, a pattern transferring apparatus 1C of this embodiment has a cleaning mechanism 17a, a supply mechanism for a mold releasing agent 7, a rinsing mechanism 17b, a drying mechanism 17c and a light emitting mechanism 17d disposed in this order from an upstream side to a downstream side (that is, from the roll 8d side to the roll 8a side) along the mold feeding pathway 15 from the roll 8d to the roll 8a. The pattern transferring apparatus 1C employs the same construction as in the pattern transferring apparatus 1B of the second embodiment except for including the cleaning mechanism 17a, the rinsing mechanism 17b, the drying mechanism 17c, and the light emitting mechanism 17d.

The cleaning mechanism 17a cleans the surface of the mold 2, and examples of such a cleaning mechanism 17a have a construction that sprays a cleaning gas like air or nitrogen, or a cleaning liquid like an aqueous solution of a surfactant to the mold 2, and a construction that performs a UV ozonization surface treatment on the mold 2.

The rinsing mechanism 17b supplies a rinsing agent to the mold 2 such that the agent makes a mold releasing layer made of the mold releasing agent applied to the mold 2 become a monomolecular film. An example of the rinsing mechanism 17b is, for example, a construction that sprays a solvent used for the preparation of the mold releasing agent solution as a rinsing agent.

The drying mechanism 17c is to dry the surface of the mold 2 treated by the cleaning mechanism 17a, the supply mechanism for a mold releasing agent 7 and the rinsing mechanism 17b. Examples of such a drying mechanism 17c include, for example, a construction that sprays a drying gas like air or nitrogen, or a construction that emits infrared rays.

The light emitting mechanism 17d is to supply the mold releasing agent to the mold 2 to be physically fixed thereto. An example of such a light emitting mechanism 17d includes a construction that emits ultraviolet rays (or UV) to the mold releasing agent.

Note the pattern transferring apparatus 1C may comprise all of the cleaning mechanism 17a, the rinsing mechanism 17b, the drying mechanism 17c, and the light emitting mechanism 17d, or include at least one of those mechanisms. It is desirable that the cleaning mechanism 17a should be disposed at the downstream side of the pressing mechanism 4B of the mold feeding pathway 15 and at the upstream side of the supply mechanism for a mold releasing agent 7. Moreover, it is desirable that the rinsing mechanism 17b, the drying mechanism 17c, and the light emitting mechanism 17d should be disposed at the downstream side of the supply mechanism for a mold releasing agent 7 and at the upstream side of the pressing mechanism 4B.

Such a pattern transferring apparatus 1C can accomplish the same advantageous effects as in the pattern transferring apparatus 1A of the first embodiment and the pattern transferring apparatus 1B of the second embodiment, and also exert the following advantageous effect.

Such a pattern transferring apparatus 1C further includes the cleaning mechanism 17a, the rinsing mechanism 17b, the drying mechanism 17c, and the light emitting mechanism 17d. Thus, it becomes possible to form the mold releasing layer excellent in the mold releasing effect and the physical fixing property compared to the pattern transferring apparatus that does not include such mechanisms.

### Fourth Embodiment

Next, an explanation will be given of in detail a fourth embodiment of the present invention with reference to the accompanying drawings as needed. In this embodiment, the same structural element as in the first to third embodiments will be denoted by the same reference numeral, and the detailed explanation thereof will be omitted.

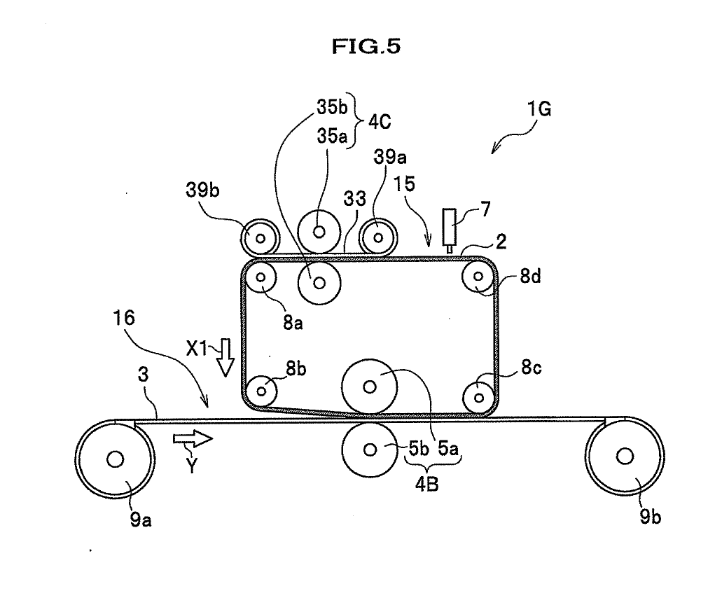

As shown in FIG. 4 of an explanatory construction diagram, a pattern transferring apparatus 1F of this embodiment includes a supply mechanism for a mold releasing agent 7 and a wipe-cleaning mechanism 17e disposed in this order from the upstream side to the downstream side (that is, from the roll 8d side to the roll 8a side) along the mold feeding pathway 15 from the roll 8d to the roll 8a. The pattern transferring apparatus 1F employs the same construction as in the pattern transferring apparatus 1B of the second embodiment except for including the wipe-cleaning mechanism 17e.

A wipe-cleaning mechanism 17e includes one that rotates a wipe-cleaning roll in association with (or in synchronization with) the feeding speed of the mold 2 while being contacting the surface of the mold 2. The wipe-cleaning roll is not limited to any particular one as long as it can contact the mold releasing layer formed on the surface of the mold 2 by the supply mechanism for a mold releasing agent 7 to wipe out the surface of the mold 2. The wipe-cleaning roll has, for example, a woven cloth or a non-woven cloth made of fibers disposed on the surface of the roll. Such a fiber includes, for example, a plant fiber, an animal fiber, a synthetic fiber, and a glass fiber or the like. The wipe-cleaning mechanism 17e can wipe (or wipe-clean) the excessive mold releasing agent on the surface of the mold 2 by contacting the mold releasing layer formed on the surface of the mold 2.

The wipe-cleaning mechanism 17e of the present invention is not limited to the roll. For example, a construction, in which brushes are disposed side by side linearly along the width direction of the mold 2 to contact the surface of the fed mold 2, may be employed.

The pattern transferring apparatus IF can not only exert the same advantageous effects as in the pattern transferring apparatus 1B of the second embodiment but also exert the following advantageous effect.

As explained above, when the non-reactive mold releasing agent is applied to the mold 2 from the supply mechanism for a mold releasing agent 7 of this embodiment, the non-reactive mold releasing agent is adsorbed on the surface of the mold 2 to form the mold releasing layer.

At this time, if an appropriate amount of the non-reactive mold releasing agent without any excess and deficiency is supplied to the patterned surface of the mold 2, the mold releasing layer is formed so as to cover the whole patterned surface of the mold 2. However, if the supply amount of the non-reactive mold releasing agent is excessive, the excessive amount of the non-reactive mold releasing agent incapable of being adsorbed on the patterned surface of the mold 2 remains so as to be overlaid on the mold releasing layer adsorbed and formed on the patterned surface.

When the pattern transfer is performed with the excessive amount of the non-reactive mold releasing agent being left, the non-reactive mold releasing agent left on the surface of the mold 2 excessively adheres to the pattern transferred surface of the transfer target material 3. The excessively adhering non-reactive mold releasing agent may negatively influence the performance of a product (or a device) obtained through the pattern transfer on the transfer target material 3.

On the other hand, according to the pattern transferring apparatus 1F, the wipe-cleaning mechanism 17e contacts the mold releasing layer on the surface of the mold 2, and eliminates in advance the excessive amount of the non-reactive mold releasing agent left on the mold releasing layer. As a result, it becomes possible for the pattern transferring apparatus 1F to suppress excessive adhering of the non-reactive mold releasing agent to the transfer target material 3 when pattern transferring is performed on the transfer target material 3, thereby reducing the probability that the excessive amount of the non-reactive mold releasing agent negatively influences the performance of the product (or the device).

### Fifth Embodiment

Next, a fifth embodiment of the present invention will be explained in detail with reference to the accompanying drawings as needed. In this embodiment, the same structural element as in the first to fourth embodiments will be denoted by the same reference numeral, and the detailed explanation thereof will be omitted.

As shown in FIG. 5 of an explanatory construction diagram, a pattern transferring apparatus 1G of this embodiment has a supply mechanism for a mold releasing agent 7, a feeder mechanism for a transfer target material 31 (39a and 39b), and a pressing mechanism 4C disposed in this order from the upstream side to the downstream side (that is, from the roll 8d side to the roll 8a side) along the mold feeding pathway 15 from the roll 8d to the roll 8a. The pattern transferring apparatus 1G employs the same construction as in the pattern transferring apparatus 1B of the second embodiment except for including the feeder mechanism for a transfer target material 31 (39a and 39b) and the pressing mechanism 4C.

The pattern transferring apparatus 1G employs a construction including the feeder mechanism for a transfer target material 31 (39a and 39b) and the pressing mechanism 4C instead of the wipe-cleaning mechanism 17e of the fourth embodiment, thereby to eliminate the non-reactive mold releasing agent excessively applied to the surface of the mold 2. Note that the transfer target material 3 of this embodiment corresponds to a “first transfer target material” described in the claims, the pressing mechanism 4B corresponds to a “first pressing mechanism” described in the claims, the feeder mechanism for a transfer target material 11 (9a and 9b) corresponds to a “feeder mechanism for a first transfer target material ” described in the claims, a transfer target material 33 corresponds to a “second transfer target material” described in the claims, the pressing mechanism 4C corresponds to a “second pressing mechanism” described in the claims, and the feeder mechanism for a transfer target material 31 (39a and 39b) corresponds to a “feeder mechanism for a second transfer target material ” described in the claims.

The feeder mechanism for a transfer target material 31 (39a and 39b) of this embodiment includes a feeder reel 39a that retains the transfer target material 33 in the rolled manner, a wind-up reel 39b that winds up the transfer target material 33 fed from the feeder reel 39a, and a driving mechanism (unillustrated) like a stepping motor that intermittently rotates and drives at least the wind-up reel 39b for each preset rotational angle to wind up the transfer target material 33. The driving mechanism intermittently rotates the wind-up reel 39b for each preset rotational angle, thereby causing the wind-up reel to intermittently wind up the transfer target material 33 for each predetermined length set in advance. In other words, the wind-up reel 39b draws the transfer target material 33 from the feeder reel 39a for each preset length by the driving mechanism, and feeds the drawn transfer target material to the pressing mechanism 4C to be discussed later.

The drive mechanism of the wind-up reel 39b of this embodiment causes the timing at which the transfer target material 33 is fed to the pressing mechanism 4C to match the timing at which the mold 2 is fed to the pressing mechanism 4C and causes the length of the transfer target material 33 fed to the pressing mechanism 4C to match the length of the mold 2 fed to the pressing mechanism 4C in synchronization with the driving mechanisms of the rolls 8a, 8b, 8c, and 8d.

That is, the pattern transferring apparatus 1G of this embodiment feeds the mold 2 and the transfer target material 33 to the pressing mechanism 4C with the mold and the transfer target material being overlapped with each other. According to this embodiment, only the wind-up reel 39b is provided with the driving mechanism, but a driving mechanism may be provided which rotates the feeder reel 39a in synchronization with the rotation of the wind-up reel 39b.

Moreover, when the mold 2 and the transfer target material 33 tightly adhere to each other, even if the feeder mechanism for a transfer target material 31 (or 39a and 39b) has no driving mechanism, both mold 2 and transfer target material 33 can be simultaneously fed by driving the mold feeder mechanism 10 (or 8a to 8d) to feed the mold 2 to the pressing mechanism 4C. Moreover, the feeder mechanism for a transfer target material 31 (or 39a and 39b) may be provided with a tension adjuster mechanism (unillustrated) that suppresses slack of the transfer target material 33.

The pressing mechanism 4C includes an upper roll 35a that rotates clockwise (right rotation) and a lower roll 35b that rotates counterclockwise (left rotation). According to the pressing mechanism 4C, the overlapping mold 2 and transfer target material 33 are supplied in between the upper roll 35a and the lower roll 35b and pressed against each other. Like the above-explained upper roll 5a and lower roll 5b (see FIG. 2), at least either of the upper roll 35a and the lower roll 35b may be provided with a heater (unillustrated).

According to such a pattern transferring apparatus 1G, after the supply mechanism for a mold releasing agent 7 has applied the non-reactive mold releasing agent, pattern transfer has been performed on the dummy transfer target material 33 before pattern transfer is performed on the transfer target material 3 thereby to form a product (or a device). Hence, the excessive amount of the non-reactive mold releasing agent on the surface of the mold 2 adheres to the dummy transfer target material 33. As a result, according to this pattern transferring apparatus 1G, when pattern transfer is performed on the transfer target material 3 by the mold 2, excessive adhesion of the non-reactive mold releasing agent to the transfer target material 3 can be prevented, thereby reducing the probability that the excessive amount of the non-reactive mold releasing agent negatively influences the performance of the product (or the device).

### Sixth Embodiment

Next, an explanation will be given of in detail a sixth embodiment of the present invention with reference to the accompanying drawings as needed. In this embodiment, the same structural element as in the first to fifth embodiments will be denoted by the same reference numeral, and the detailed explanation thereof will be omitted.

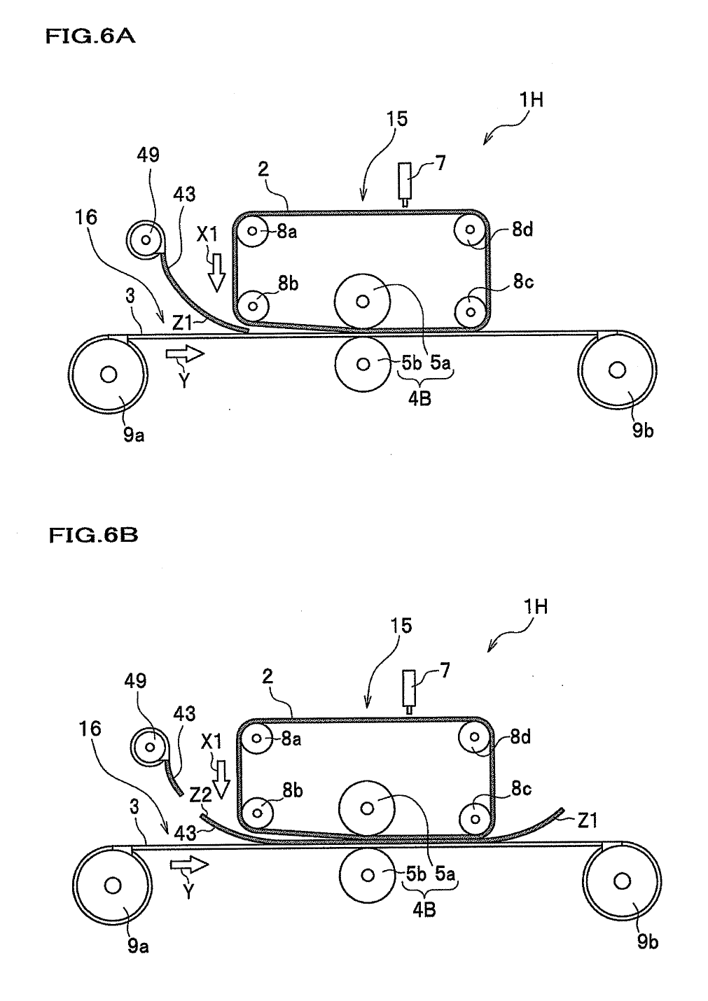

As shown in FIG. 6A of an explanatory construction diagram, a pattern transferring apparatus 1H of this embodiment includes a supply mechanism for a protective material 49 for supplying a protective material 43 between the mold 2 and the transfer target material 3 until the mold 2 is fed from the roll 8b to the pressing mechanism 4B. The protective material 43 corresponds to a “protective material for a transfer target material” described in the claims.

The pattern transferring apparatus 1H is especially appropriate for a case in which, for example, the supply mechanism for a mold releasing agent 7 uses a mold releasing agent having a remarkably superior mold releasing performance to the mold 2, but relatively needs a time to be fixed on the mold 2.

The protective material 43 is present between the mold 2 and the transfer target material 3 pressed against each other under a predetermined heated condition between the upper roll 5a and the lower roll 5b constructing the pressing mechanism 4B. The protective material 43 is present between the mold 2 and the transfer target material 3, thereby protecting the transfer target material 3 as will be discussed hereinafter.

The protective material 43 is not limited to any particular one as long as it does not adhere to the transfer target material 3 and the upper roll 5a and the lower roll 5b, and has a heat resistance property to the heating temperature of the upper roll 5a and the lower roll 5b when pattern transferring is performed on the transfer target material 3. A specific example of such a protective material 43 is a resin film or a resin sheet having a higher glass transition temperature Tg than the heating temperature of the upper roll 5a and the lower roll 5b. In particular, a protective material 43 having a higher glass transition temperature Tg than the glass transition temperature Tg of the transfer target material 3 is desirable.

A supply mechanism for a protective material 49 represents a reel 49 which has the protective material 43 formed in the tape or belt shape rolled up on such a reel, and feeds the protective material 43 between the mold 2 and the transfer target material 3. The supply mechanism for a protective material 49 may include an unillustrated driving device (e.g., a motor) which rotates the reel 49 at a predetermined rotational speed and feeds the protective material 43 at a predetermined speed. Moreover, the supply mechanism for a protective material 49 may further include an unillustrated cutting mechanism which cuts the protective material 43 after being fed at a predetermined length as discussed hereinafter.

Next, an explanation will be given of an operation of the pattern transferring apparatus 1H of this embodiment. According to the pattern transferring apparatus 1H of this embodiment, as explained above, when the mold 2 performs pattern transferring on the transfer target material 3 and the supply mechanism for a mold releasing agent 7 applies the mold releasing agent to the mold 2, it may relatively need a time for fixing the mold releasing agent on the mold 2. On the other hand, it is necessary to feed the mold 2 at a predetermined speed when pattern transferring is performed on the transfer target material 3. If the feeding speed of the mold 2 and the transfer target material 3 is fast, those mold 2 and transfer target material 3 reach the position of the pressing mechanism 4B with the fixing of the mold releasing layer being insufficient. As a result, without a sufficient mold releasing performance being accomplished, the mold 2 performs pattern transferring on the transfer target material 3, and thus the mold 2 and the transfer target material 3 may adhere to each other, resulting in the transferring failure.

Hence, until the fixing of the mold releasing layer on the mold 2 completes (or until the fixing process completes), once the press by the upper roll 5a and the lower roll 5b constructing the pressing mechanism 4B may be terminated, the upper roll 5a and the lower roll 5b may be moved apart from each other so as to avoid the mold 2 and the transfer target material 3 to contact with each other. Then, the pattern transferring may be performed again after the fixing of the mold releasing layer completes.

Meanwhile, as explained above, in the process of moving the upper roll 5a and the lower roll 5b apart from each other after the press by the upper roll 5a and the lower roll 5b are once terminated, there is a moment when the feeding of the mold 2 and the transfer target material 3 is interrupted with the upper roll 5a and the lower roll 5b being contacting the mold 2 and the transfer target material 3. Hence, the transfer target material 3 halted between the upper roll 5a and the lower roll 5b may become at a higher temperature than the temperature thereof while the transfer target material 3 is fed, and may be damaged (e.g., cause fusing). Moreover, the mold 2 is performing the pattern transferring on the transfer target material 3 right before the upper roll 5a and the lower roll 5b are moved apart from each other. Accordingly, the convex concave pattern of the mold 2 is bit into the transfer target material 3. Hence, when it is attempted to forcibly release the mold 2 from the transfer target material 3, this may cause a deformation of the transfer target material 3. Such breakage and deformation of the transfer target material 3 lower productivity of the product (or the device) obtained by performing the pattern transferring on the transfer target material 3.

In contrast, according to the pattern transferring apparatus 1H of this embodiment, the supply mechanism for a protective material 49 supplies the protective material 43 between the transfer target material 3 and the mold 2 to protect the transfer target material 3. That is, as shown in FIG. 6B of an explanatory operation diagram, when the supply mechanism for a mold releasing agent 7 supplies the mold releasing agent to the surface of the mold 2, the pattern transferring apparatus 1H has the supply mechanism for a protective material 49 supply the protective material 43 between the transfer target material 3 and the mold 2.

The length of the protective material 43 supplied from the supply mechanism for a protective material 49 of this embodiment is set to be longer than the length between the pressing mechanism 4B (that is, the upper roll 5a and the lower roll 5b) and the roll 8c, desirably, the length between the rolls 8b and 8c. Moreover, according to the supply mechanism for a protective material 49 of this embodiment, as shown in FIG. 6B, after the protective material 43 of the predetermined length is fed, the above-explained cutting mechanism (unillustrated) cuts the protective material 43.

A front end Z1 of the protective material 43 is inserted between the mold 2 and the transfer target material 3 pressed and fed between the upper roll 5a and the lower roll 5b. Then, the front end Z1 passes through the space between the upper roll 5a and the lower roll 5b. After the front end Z1 passes through the roll 8c, the protective material 43 is present on the whole contacting surface between the mold 2 and the transfer target material 3. As a result, according to the pattern transferring apparatus 1H, when the upper roll 5a and the lower roll 5b are moved apart from each other, even if, as explained above, the transfer target material 3 is halted between the upper roll 5a and the lower roll 5b, i.e., the transfer target material 3 is heated to a higher temperature than a temperature while the transfer target material 3 is fed, the protective material 43 is present between the mold 2 and the transfer target material 3. Accordingly, it becomes possible to prevent the transfer target material 3 from being damaged and deformed, and the transfer target material 3 can be removed from the mold 2. Therefore, according to the pattern transferring apparatus 1H, it becomes possible to prevent the transfer target material 3 from being damaged and deformed, thereby maintaining the good productivity of the product (or the device).

Moreover, in the pattern transferring apparatus 1H, after the upper roll 5a and the lower roll 5b are moved apart from each other to move the mold 2 apart from the transfer target material 3 and a predetermined time elapses, when sufficient fixing of the mold releasing layer to the surface of the mold 2 is obtained, the protective material 43 is removed between the transfer target material 3 and the mold 2. Then, the mold 2 and the transfer target material 3 are fed while being pressed again between the upper roll 5a and the lower roll 5b to perform pattern transferring again.

An example technique of removing the protective material 43 between the transfer target material 3 and the mold 2 is to collect the front end Z1 of the protective material 43 by a collecting mechanism (unillustrated) like a reel that winds up the protective material 43. According to this technique, a rear end Z2 of the protective material 43 passes through the roll 8c, thereby to remove the protective material 43 from the space between the transfer target material 3 and the mold 2.

According to the pattern transferring apparatus 1H, the above mentioned operation is repeated, every time the supply mechanism for a mold releasing agent 7 supplies the mold releasing agent to the surface of the mold 2.

Moreover, when the pattern transferring is restarted, it is necessary that the pressing mechanism 4B (or the upper roll 5a and the lower roll 5b) satisfies predetermined pattern transfer conditions (that is, a heating temperature and a pressing force at the time of pattern transferring). However, as explained above, when the feeding of the transfer target material 3 is terminated, a temperature of the transfer target material 3 may become higher than a temperature while it is fed, and may be damaged (e.g., melted and broken). Accordingly, it is also necessary that the feeding speed of the transfer target material 3 reaches a predetermined speed.

In contrast, according to the pattern transferring apparatus 1H, after the pressing mechanism 4B satisfies the predetermined pattern transfer conditions, the supply mechanism for a protective material 49 can supply the protective material 43 between the transfer target material 3 and the mold 2 to have the protective material present therebetween until the feeding speed of the transfer target material 3 reaches the predetermined speed after the restart of the feeding thereof. As a result, according to the pattern transferring apparatus 1H, it becomes possible to prevent the transfer target material 3 from being damaged and deformed when restarting the pattern transferring.

The time for having the protective material 43 present between the transfer target material 3 and the mold 2 can be set as needed depending on the set pattern transfer conditions and feeding speed of the transfer target material 3. Herein, the time adjustment can be carried out by adjusting the length (or a distance between the front end Z1 and the rear end Z2) of the protective material 43 shown in FIG. 6B.

The explanation has been given of the first to sixth embodiments of the present invention, while the present invention is not limited to the above-explained embodiments, and can be changed and modified in various forms. In the following other embodiments, the same structural element as in the first to sixth embodiments will be denoted by the same reference numeral, and the detailed explanation thereof will be omitted.

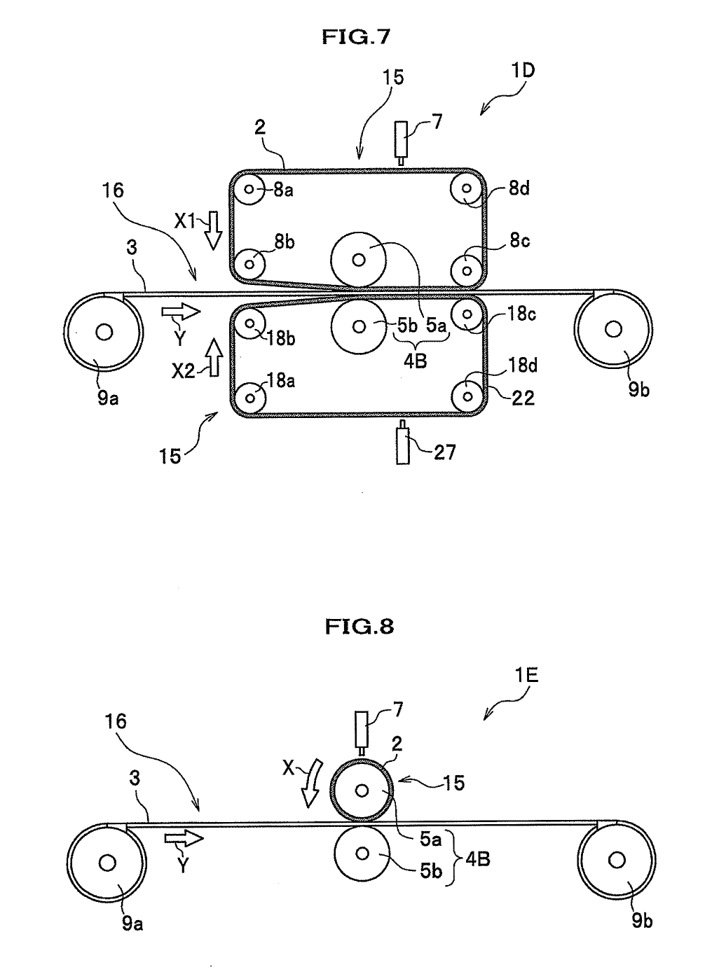

In the second embodiment, as shown in FIG. 2, a construction is assumed based on the convex concave pattern being transferred on one surface side of the transfer target material 3. However, the present invention may employ a construction of transferring the convex concave pattern on both surface sides of the transfer target material 3. FIG. 7 to be referred next is an explanatory construction diagram showing a modified example of the pattern transferring apparatus according to the second embodiment of the present invention.

As shown in FIG. 7, a pattern transferring apparatus 1D comprises rolls 18a, 18b, 18c, and 18d, a mold 22, and a supply mechanism for a mold releasing agent 27 disposed under the transfer target material 3 in such a manner as to be linearly symmetric to the rolls 8a, 8b, 8c, and 8d, the mold 2, and the supply mechanism for a mold releasing agent 7 disposed above the transfer target material 3 around a symmetrical axis that is the 5 feeding pathway for a transfer target material 16. In FIG. 7, an arrow indicated by a reference symbol X1 indicates the feeding direction of the mold 2, and an arrow indicated by a reference symbol X2 indicates the feeding direction of the mold 22.

According to such a pattern transferring apparatus 1D, the mold 2 supplied to the pressing mechanism 4B by the rolls 8a, 8b, 8c, and 8d transfers the convex concave 10 pattern on a front face of the transfer target material 3, while at the same time, the mold 22 supplied to the pressing mechanism 4B by the rolls 18a, 18b, 18c, and 18d transfers a convex concave pattern on a rear face of the transfer target material 3.

The pattern transferring apparatus 1A (see FIG. 1) of the first embodiment, the pattern transferring apparatus 1C (see FIG. 3) of the third embodiment, the pattern 15 transferring apparatus 1F (see FIG. 4) of the fourth embodiment, the pattern transferring apparatus 1G (see FIG. 5) of the fifth embodiment, and the pattern transferring apparatus 1H (see FIG. 6A) of the sixth embodiment can have the rolls 18a, 18b, 18c, and 18d, the mold 22, and the supply mechanism for a mold releasing agent 27 disposed under the transfer target material 3 in such a manner as to be linearly symmetrical to the rolls 8a, 8b, 8c, and 8d, the mold 2 and the supply mechanism for a mold releasing agent 7 disposed above the transfer target material 3 around a symmetrical axis that is the feeding pathway for a transfer target material 16.

Moreover, the pattern transferring apparatus 1D may have at least one of the cleaning mechanism 17a, the rinsing mechanism 17b, the drying mechanism 17c, and the light emitting mechanism 17d (see FIG. 3) per each of the upper and lower mold feeding pathways 15, 15.

Furthermore, the pattern transferring apparatus 1D may have a wipe-cleaning mechanism 17e (see FIG. 4) per each of the upper and lower mold feeding pathways 15, 15.

The pattern transferring apparatus 1D may have the pressing mechanism 4C (see FIG. 5) and the feeder mechanism for a transfer target material 31 (or 39a and 39b) (see FIG. 5) per each of the upper and lower mold feeding pathways 15, 15.

The pattern transferring apparatus 1D may have the supply mechanism for a protective material 41 (or 49) (see FIG. 6A) per each of the upper and lower mold feeding pathways 15, 15.

In the above-explained first to sixth embodiments, the explanation has been given of the case that only the pattern transferring apparatus 1C among the pattern transferring apparatuses 1 A, 1 B, 1 C, 1 F, 1G and 1H employs a construction of having the cleaning mechanism 17a, the supply mechanism for a mold releasing agent 7, the rinsing mechanism 17b, the drying mechanism 17c, and the light emitting mechanism 17d (see FIG. 3) or the like. However, the pattern transferring apparatuses 1A, 1B, 1F, 1G and 1H may have at least one of the cleaning mechanism 17a, the supply mechanism for a mold releasing agent 7, the rinsing mechanism 17b, the drying mechanism 17c, and the light emitting mechanism 17d.

According to the above-explained first to sixth embodiments, only the pattern transferring apparatus 1F among the pattern transferring apparatuses 1A, 1B, 1C, 1F, 1Q and 1H employs a construction of having the wipe-cleaning mechanism 17e (see FIG. 4). However, the pattern transferring apparatuses 1A, 1B, 1C, 1Q and 1H may employ a construction of having the wipe-cleaning mechanism 17e.

According to the above-explained first to sixth embodiments, only the pattern transferring apparatus 1G among the pattern transferring apparatuses 1A, 1B, 1C, 1F, 1G and 1H employs a construction of having the pressing mechanism 4C (see FIG. 5) and the feeder mechanism for a transfer target material 31 (39a and 39b) (see FIG. 5). However, the pattern transferring apparatuses 1A, 1B, 1C, 1F, and 1H may employ a construction of having the pressing mechanism 4C (see FIG. 5) and the feeder mechanism for a transfer target material 31 (or 39a and 39b) (see FIG. 5).

According to the above-explained first to sixth embodiments, only the pattern transferring apparatus 1H among the pattern transferring apparatuses 1A, 1B, 1C, 1F, 1G and 1H employs a construction of having the supply mechanism for a protective material 41 (or 49) (see FIG. 6A). However, the pattern transferring apparatuses 1A, 1B, 1C and 1F may employ a construction of having the supply mechanism for a protective material 41 (or 49) that supplies the protective material 43 in between the mold 2 and the transfer target material 3. Moreover, the pattern transferring apparatus 1G may have the supply mechanism for a protective material 49 (or a supply mechanism for a first protective material) that supplies the protective material 43 in between the mold 2 and the transfer target material 3 (or the first transfer target material). Furthermore, the pattern transferring apparatus 1G may have a supply mechanism for a protective material (or a supply mechanism for a second protective material) that supplies a protective material like the protective material 43 in between the mold 2 and the transfer target material 33 (or the second transfer target material). Such pattern transferring apparatuses 1A, 1B, 1C, 1F, 1G, and 1H can prevent the transfer target materials 3 and 33 from being damaged or deformed.

Here, the above-explained pattern transferring apparatuses 1A, 1B, 1C, 1D, 1F, 1G and 1H use the endless-belt-shaped molds 2 and 22. However, the present invention is not limited to this shape of the mold, and a long-belt-shaped mold 2 can be used. A mold feeder mechanism of such a pattern transferring apparatus can employ a construction which is not illustrated in the figure. For example, the mold feeder mechanism includes, for example, a feeder reel that rolls up an end of the long-belt-shaped mold 2 to feed such a mold 2, and a wind-up reel that winds up another end of such a mold. Moreover, although it is not illustrated in the figure, if the mold is a caterpillar-shaped mold having a plurality of molds divided intermittently but joined one another, the same advantageous effects can be apparently obtained as another form of the mold.

### EXAMPLES

### Example 1

In this example, the pattern transferring apparatus 1A shown in FIG. 1 was used to transfer the convex concave pattern of the mold 2 to the transfer target material 3. The mold 2 used in this example included an annular stainless-steel belt having a thickness of 100 μm, a width of 200 mm, and a circumferential length of 2 m. Herein, cut pieces each of which had a convex concave pattern were bonded on an external circumference of the belt by an adhesive agent, having a thickness of 100 μm, a width of 100 mm and a length of 100 mm. Next, the mold having a fluorinated mold releasing agent of the non-reactive mold releasing agent applied to the convex concave pattern in advance was attached to the pattern transferring apparatus 1A. The employed convex concave pattern was comprised of a plurality of holes each of which was disposed at a vertex of an equilateral triangle in a planar view, to arrange a series of hexagonal shapes. A diameter of each hole was 500 nm, a depth thereof was 400 nm, and a pitch of the holes was 1000 nm.

As the transfer target material 3, an elongated polystyrene film having a thickness of 400 μm and a width of 150 mm was prepared. The supply mechanism for a mold releasing agent 7 supplied a fluorinated mold releasing agent of a non-reactive mold releasing agent to the convex concave pattern (or the cut pieces) of the mold 2. The convex concave pattern transferred to the transfer target material 3 from the mold 2 was comprised of columnar structures having the inverted convex concave pattern of the mold 2, with a columnar width of 500 nm, a height of 400 nm and a pitch of 1000 nm.

Next, a pattern defective rate of the convex concave pattern transferred to the transfer target material 3 was calculated. The pattern defective rate was defined as a rate (%) of the number of defective columns present per 1 mm² of the transferred convex concave pattern. The pattern defective rate calculated in Example 1 was 4×10⁻⁴%.

Moreover, using the pattern transferring apparatus 1A, the transferring of the convex concave pattern from the mold 2 was repeated 50 times while the non-reactive mold releasing agent was being supplied to the mold 2 from the supply mechanism for a mold releasing agent 7. Next, the pattern defective rate of the convex concave pattern after 50 times transferred to the transfer target material 3 was calculated. As a result, the pattern defective rate was substantially 0.02%.

### Comparative Example 1

In this comparative example, the pattern transferring apparatus 1A having the mold 2 to which the fluorinated mold releasing agent of the non-reactive mold releasing agent was applied in advance was used the same as in Example 1 except that only the supply mechanism for a mold releasing agent 7 was removed from the apparatus 1A shown in FIG. 1. Next, the convex concave pattern of the mold 2 was repeatedly transferred 50 times to the transfer target material 3. The pattern defective rate of the convex concave pattern after 50 times transferred to the transfer target material 3 was calculated. As a result, the pattern defective rate was 0.24%.

### Example 2

In this example, the pattern transferring apparatus 1A (see FIG. 1) the same as in Example 1 was used except that the mold 2 to which a reactive mold releasing agent (a silane coupling agent) was applied in advance was attached to such an apparatus 1A instead of the mold 2 to which the non-reactive mold releasing agent was applied in advance. Next, using this pattern transferring apparatus 1A, the transferring of the convex concave pattern by the mold 2 was repeatedly performed 2000 times while the same non-reactive mold releasing agent as in Example 1 was being applied to the mold 2 from the supply mechanism for a mold releasing agent 7. The pattern defective rate of the convex concave pattern after 2000 times transferred to the transfer target material 3 was calculated. As a result, the pattern defective rate was 0.47%.

### Comparative Example 2

In this comparative example, the transferring of the convex concave pattern by the mold 2 to which the reactive mold releasing agent (or the silane coupling agent) was applied in advance was repeatedly performed 2000 times the same as in Example 2 except that the non-reactive mold releasing agent was not supplied to the mold 2 from the supply mechanism for a mold releasing agent 7. The pattern defective rate of the convex concave pattern after 2000 times transferred to the transfer target material 3 was calculated. As a result, the pattern defective rate was 1.58%.

<Evaluation Results of Pattern Defective Rate>

According to Comparative Example 1 in which no mold releasing agent was applied to the mold 2 per each transferring of the convex concave pattern, the pattern defective rate of the convex concave pattern after 50 times transferred to the transfer target material 3 was 0.24%. In contrast, according to Example 1 in which the mold releasing agent was applied to the mold 2 per each transferring of the convex concave pattern, the pattern defective rate of the convex concave pattern after 50 times transferred to the transfer target material 3 was 0.02%, resulting in the remarkably low defective rate. That is, it is confirmed that according to the pattern transferring apparatus 1A and the pattern transferring method in Example 1, even if the pattern transfer is repeated, the good mold releasing performance can be maintained and the pattern transfer can be continuously executed without a renewable process of the mold.

Moreover, even if the mold 2 to which the reactive mold releasing agent was applied in advance was used, when the transferring of the convex concave pattern was repeated 2000 times, like Comparative Example 2, the pattern defective rate reached 1.58%. In contrast, according to Example 2 in which the non-reactive mold releasing agent was applied to the mold 2 per each transferring of the convex concave pattern, even if the transferring of the convex concave pattern was repeated 2000 times, the pattern defective rate was 0.47%, resulting in the remarkably low defective rate. That is, it is confirmed that according to the pattern transferring apparatus 1A and the pattern transferring method in Example 2, a second mold releasing layer (or a mold releasing layer made of the non-reactive mold releasing agent) can be continuously formed again on a first mold releasing layer (or a mold releasing layer made of the reactive mold releasing agent) per each transferring of the convex concave pattern,. Accordingly, the good mold releasing performance can be maintained.

### Comparative Example 3

In this comparative example, a pattern transferring apparatus 1E shown in FIG. 8 was used, and the convex concave pattern of the mold 2 was transferred to the transfer target material 3. FIG. 8 is an explanatory construction diagram of a pattern transferring apparatus shown as a comparative example. As shown in FIG. 8, the pattern transferring apparatus 1E in Comparative Example 3 had the mold 2 disposed on the circumferential surface of the upper roll 5a having a heater built therein, and the pressing mechanism 4B also served as the mold 2. The supply mechanism for a mold releasing agent 7 was disposed so as to be able to supply the mold releasing agent to the convex concave pattern of the mold 2.

According to such a pattern transferring apparatus 1E, the above-explained pressing-transfer process was performed between the upper roll 5a and the lower roll 5b. At that time, the upper roll 5a was heated by an unillustrated heater, whereby the upper roll 5a was to heat the transfer target material 3. Next, when the transfer target material 3 passed through the space between the upper roll 5a and the lower roll 5b the above-explained releasing process was executed, and the supplying process for the mold releasing agent was executed when the supply mechanism for a mold releasing agent 7 supplied the mold releasing agent to the rotating upper roll 5a.

When the pressing-transfer process was executed while executing the supplying process for the mold releasing agent through such a pattern transfer apparatus 1E, the mold releasing agent supplied from the supply mechanism for a mold releasing agent 7 to the surface of the mold 2 was instantaneously vaporized due to the heat of the mold 2 and did not reach the contact surface between the transfer target material 3 and the mold 2. Moreover, in the releasing process, the transfer target material 3 heated by the upper roll 5a was released from the mold 2 of the upper roll 5a before the transfer target material was sufficiently cooled. Accordingly, a transfer failure to the transfer target material 3 was observed.

### DESCRIPTION OF REFERENCE NUMERALS

1A Pattern transferring apparatus
1B Pattern transferring apparatus
1C Pattern transferring apparatus
1D Pattern transferring apparatus
1E Pattern transferring apparatus
1F Pattern transferring apparatus
1G Pattern transferring apparatus
1H Pattern transferring apparatus
2 Mold
3 Transfer target material
4A Pressing mechanism
4B Pressing mechanism
4C Pressing mechanism
5a Upper roll
5b Lower roll
6a Upper pressing member
6b Lower pressing member
7 Supply mechanism for a mold releasing agent
8a Roll
8b Roll
8c Roll
8d Roll
9a Reel
9b Reel
10 Mold feeder mechanism
11 Feeder mechanism for a transfer target material
15 Mold feeding pathway
16 Feeding pathway for a transfer target material
17a Cleaning mechanism
17b Rinsing mechanism (or a supply mechanism for a rinse solution)
17c Drying mechanism
17d Light emitting mechanism
17e Wipe-cleaning mechanism
18a Roll
18b Roll
18c Roll
18d Roll
22 Mold
27 Supply mechanism for a mold releasing agent
31 Feeder mechanism for a transfer target material
33 Transfer target material
35a Upper roll
35b Lower roll
39a Reel
39b Reel
41 Supply mechanism for a protective material
43 Protective material (or protective material for a transfer target material)
49 Reel

1-30. (canceled)

31. A pattern transferring apparatus which presses a belt-shaped mold with a fine convex concave pattern and a transfer target material against each other, and transfers the convex concave pattern on a surface of the transfer target material by releasing the mold from the transfer target material,
the pattern transferring apparatus comprising:
a pressing mechanism that presses the mold and the transfer target material against each other;
a mold feeder mechanism that feeds the mold along a mold feeding pathway defined in advance so as to supply the mold to the pressing mechanism;
a feeder mechanism for a transfer target material that feeds the transfer target material along a feeding pathway for a transfer target material defined in advance so as to feed the transfer target material to the pressing mechanism; and
a supply mechanism for a mold releasing agent, which supplies a mold releasing agent to the mold over the mold feeding pathway.

32. The pattern transferring apparatus according to claim 31, further comprising at least one of:
a drying mechanism that dries the mold releasing agent supplied to the mold;
a cleaning mechanism that cleans the mold over the mold feeding pathway;
a supply mechanism for a rinse solution that supplies a rinse solution to a mold releasing layer formed of the mold releasing agent supplied to the mold;
a light emitting mechanism that emits light to the mold releasing agent to fix the mold releasing agent on the mold;
a wipe-cleaning mechanism that contacts with the mold releasing layer formed of the mold releasing agent supplied to the mold to wipe off the mold; and
a supply mechanism for a protective material, which supplies a protective material for a transfer target material placed between the mold and the transfer target material.

33. The pattern transferring apparatus according to claim 31, wherein the belt-shaped mold is disposed over the mold feeding pathway in an annular shape and is fed to the pressing mechanism in an endless manner.

34. The pattern transferring apparatus according to claim 31, wherein the pressing mechanism includes at least a pair of rolls that holds therebetween the mold and the transfer target material overlapped with each other.

35. The pattern transferring apparatus according to claim 31, wherein the mold is made of a metallic material containing nickel.

36. The pattern transferring apparatus according to claim 31, wherein the mold is made of a resin material containing a polyimide resin or a photo-curable resin.

37. The pattern transferring apparatus according to claim 31, wherein the mold releasing agent supplied from the supply mechanism for a mold releasing agent is a fluorinated mold releasing agent having a polar group at a molecular end.

38. The pattern transferring apparatus according to claim 37, wherein the polar group is at least one member selected from a hydroxyl group, an ether group and an ester group.

39. The pattern transferring apparatus according to claim 31, further comprising a first mold releasing layer formed in advance on a surface of the mold.

40. The pattern transferring apparatus according to claim 39, wherein the first mold releasing layer formed in advance on the surface of the mold is made of a different kind of a material from a material of the mold releasing agent supplied from the supply mechanism for a mold releasing agent.

41. A pattern transferring apparatus which presses a belt-shaped mold with a fine convex concave pattern and a first transfer target material against each other, and releases the mold from the first transfer target material to transfer the convex concave pattern on a surface of the first transfer target material, the apparatus comprising:
a first pressing mechanism that presses the mold and the first transfer target material against each other;
a mold feeder mechanism that feeds the mold along a mold feeding pathway defined in advance so as to supply the mold to the first pressing mechanism;
a feeder mechanism for a first transfer target material, which feeds the first transfer target material along a feeding pathway for a first transfer target material defined in advance so as to supply the first transfer target material to the first pressing mechanism;
a supply mechanism for a mold releasing agent, which supplies the mold releasing agent to the mold over the mold feeding pathway;
a second pressing mechanism which is disposed at an upstream side of the mold feeding pathway over the first pressing mechanism, and presses the mold and a second transfer target material against each other; and
a feeder mechanism for a second transfer target material, which feeds the second transfer target material so as to supply the second transfer target material to the second pressing mechanism.

42. The pattern transferring apparatus according to claim 41 further comprising at least one of:
a drying mechanism that dries the mold releasing agent supplied to the mold;
a cleaning mechanism that cleans the mold over the mold feeding pathway;
a supply mechanism for a rinse solution that supplies a rinse solution to a mold releasing layer formed of the mold releasing agent supplied to the mold;
a light emitting mechanism that emits light to the mold releasing agent to fix the mold releasing agent on the mold;
a wipe-cleaning mechanism that contacts the mold releasing layer formed of the mold releasing agent supplied to the mold to wipe off the mold;
a supply mechanism for a first protective material that supplies a protective material for a first transfer target material in between the mold and the first transfer target material; and
a supply mechanism for a second protective material, which supplies a protective material for a second transfer target material in between the mold and the second transfer target material.

43. The pattern transferring apparatus according to claim 41, wherein the belt-shaped mold is disposed over the mold feeding pathway in an annular shape and is fed to both first pressing mechanism and second pressing mechanism in an endless manner.

44. The pattern transferring apparatus according to claim 41, wherein the first pressing mechanism and the second pressing mechanism each includes at least a pair of rolls that hold the mold and the first transfer target material or the second transfer target material therebetween overlapped with each other.

45. The pattern transferring apparatus according to claim 41, wherein the mold is made of a metallic material containing nickel.

46. The pattern transferring apparatus according to claim 41, wherein the mold is made of a resin material including a polyimide resin or a photo-curable resin.

47. The pattern transferring apparatus according to claim 41, wherein the mold releasing agent supplied from the supply mechanism for a mold releasing agent is a fluorinated mold releasing agent having a polar group at a molecular end.

48. The pattern transferring apparatus according to claim 47, wherein the polar group is at least one member selected from a hydroxyl group, an ether group and an ester group.

49. The pattern transferring apparatus according to claim 41, further comprising a first mold releasing layer formed in advance on a surface of the mold.

50. The pattern transferring apparatus according to claim 49, wherein the first mold releasing layer formed in advance on the surface of the mold is made of a different kind of a material from a material of the mold releasing agent supplied from the supply mechanism for a mold releasing agent.
